(19) United States
(12) Patent Application Publication
(10) Pub. No.: US 2002/0012537 A1
(43) Pub. Date: Jan. 31, 2002

(54) MAGNETIC RECORDING INFORMATION READING DEVICE

(76) Inventors: YOSHIHARU TANAKA, KAWACHINAGANO-SHI (JP); JUNICHI TANII, IZUMI-SHI (JP); SHOICHI MINATO, SAKAI-SHI (JP); AKIRA KOSAKA, YAO-SHI (JP)

Correspondence Address: BURNS DOANE SWECKER & MATHIS L L P, POST OFFICE BOX 1404, ALEXANDRIA, VA, 22313-1404, US

(21) Appl. No.: 09/264,879

(22) Filed: Mar. 9, 1999

(30) Foreign Application Priority Data
Mar. 26, 1998 (JP) 10-96925

(51) Int. Cl. G03B 17/24

(52) U.S. Cl. 396/319

(57) ABSTRACT

A magnetic recording information reading device for reading information magnetically recorded on a film capable of being used in reading the magnetic recording information on the film in a camera. A magnetic head is attached on a movable support member in a direction reverse to a direction of transferring the film and the magnetic head is arranged at a position opposed to a magnetic recording portion on the film. In reading information recorded on the film, the magnetic head is moved in the direction reverse to the direction of transferring the film. Thereby, the magnetic head is moved at a speed faster than a speed of transferring the film and therefore, the recorded information can firmly be read even when the speed of transferring the film is lowered by lowering power source voltage or the like.

This application is based on patent application No. 10-96925 filed in Japan, the contents of which is hereby incorporated by reference.

### BACKGROUND OF THE INVENTION

1. Field of the Invention

The present invention relates to a magnetic recording information reading device and particularly to a magnetic recording information reading device suitable for a device of using a film cartridge capable of magnetically recording information on a film.

2. Prior Art

A film used in a camera referred to as APS (Advanced Photo System) is installed with a magnetic recording portion on the film and the magnetic recording portion can be recorded with various information, for example, date and time of photographing and so on in photographing respective frames by a camera mounted with a write head. Information such as information of date and time of photographing and so on recorded on a magnetic recording portion is read in developing or printing the film and can be used for printing the information of date and time of photographing and the like on photographic paper along with picture image.

In the meantime, in a camera mounted with a write head, various information in photographing are recorded on a magnetically recording portion mentioned above in respect of exposed frames and therefore, no magnetic recording information is provided to unexposed frames.

By utilizing such a situation, according to a camera mounted with a read head, even when film cartridges are interchanged and reloaded in the midway of photographing operation, photographing can be restarted from a frame successive to a final exposed frame. That is, in the case in which a film is rewound to a cartridge under a state where photographing operation has been carried out only in respect of a portion of frames on the film, the cartridge is unloaded from the camera and is interchanged by other cartridge to thereby continue photographing operation and thereafter, the previous cartridge is again reloaded to the camera, after initial load (operation of winding the film to the first frame when the cartridge is loaded to the camera) has been finished, the film is wound up while detecting presence or absence of information of the magnetic recording portion by the read head and the film is wound up until a frame not recorded with the magnetic recording information is detected, then the first unexposed frame can be set to a photographing frame position.

In a camera mounted with a write head, it is adjusted such that an angle (azimuth angle) made by a magnetism change boundary line of a magnetic recording portion recorded in feeding a film and a center line of a gap of the head becomes within a predetermined angle (for example, ±0.85).

In the meantime, in reading magnetic recording information by a read head, information recorded in a magnetic recording portion is read by presence or absence of a change in output signal which is caused when a magnetism change boundary line passes through on a gap of the read head in feeding a film and in that case, in respect of an angle made by a center line of the gap of the read head and the magnetism change boundary line, it is preferable that the both are in parallel with each other and when there is an angular difference therebetween, there causes a drawback in which an output from the read head is reduced.

In order to prevent the drawback, two pins are implanted on a plate attached to a write/read head and the pins are pressed to end faces of a film whereby a relative position between the head and the end faces of the film is stabilized and the angle made by the center line of the gap of the head and the magnetism change boundary line of the magnetic recording portion is made to fall within a predetermined angle.

However, according to a camera mounted with a write only head, information recorded on a magnetic recording portion is not read and accordingly, there is a case in which the angle (azimuth angle) made by a magnetism change boundary line of the magnetic recording portion and the center line of a gap of the head is not set strictly within a predetermined angle. When the magnetic recording information on a film recorded by such a camera is read by other camera or a read head of other device, there is a possibility in which the magnetic recording information cannot accurately be read such as an output signal level is lowered and the output signal is concealed by the magnetic noise or the like.

Further, the level of an output signal caused when a magnetism change boundary line of the magnetic recording portion passes through a gap of a read head in feeding a film, is dependent on the film feed speed, the faster the feed speed, the larger becomes the output signal and accordingly, when the film feed speed is fast, a sufficient level of the output signal can be taken out even when the azimuth angle is more or less deviated from an allowable value.

Accordingly, in order to firmly read information recorded in the magnetic recording portion, it is preferable to accelerate the film feed speed and to provide a film edge guide mechanism for guiding end faces of a film such that the angle (azimuth angle) made by the center line of a gap of a read head and a magnetism change boundary line of the magnetic recording portion falls in a predetermined angular range.

However, in order to accelerate the film feed speed, a large-sized motor needs to use and in providing the film edge guide mechanism, the camera becomes large-sized in any case, resulting in a drawback of increasing the fabrication cost. SUMMARY OF THE INVENTION

It is an principal object of the invention to provide a magnetic recording information reading device capable of reading information magnetically recorded on a film.

It is another object of the invention to provide a magnetic recording information reading device capable of reading recorded information with further certainty by moving a magnetic head placed on a magnetic recording portion at a speed faster than speed of transferring a film.

It is another object of the invention to provide a magnetic recording information reading device having a moving mechanism for moving a magnetic head placed on a magnetic recording portion at a speed faster than the speed of transferring a film.

It is another object of the invention to provide a novel camera having a recorded information reading device capable of moving a magnetic head placed on a magnetic recording portion at a speed faster than the speed of transferring a photographic film in a camera using the photographic film having the magnetic recording portion.

Other objects of the invention will become apparent from a detailed explanation of the invention in reference to attached drawings.

### BRIEF DESCRIPTION OF THE DRAWINGS

FIG. 1 is a drawing for explaining a film cartridge for APS loaded in a camera, a spool, a film and a position of a magnetic recording portion thereof and a constitution related thereto;

FIG. 2 is a drawing for explaining the constitution of an inner portion of a rear face of the camera according to the first embodiment;

FIG. 3 is a perspective view for explaining a mechanism of driving a cam according to the first embodiment;

FIG. 4 is a drawing for explaining the constitution of an inner portion of a rear face of a camera according to a second embodiment;

FIG. 5 is a perspective view for explaining a mechanism of driving a cam according to the second embodiment;

FIG. 6 is a plane view for explaining other example of a shape of a cam;

FIG. 7 is a drawing for explaining the constitution of an inner portion of a rear face of a camera according to a third embodiment;

FIG. 8 is a drawing for explaining the constitution of an inner portion of a rear face of a camera according to a fourth embodiment;

FIG. 9 is block diagram for explaining the constitution of a control circuit of a magnetic recording information reading device; and

FIG. 10 is a flowchart for explaining control operation of a control mechanism of a camera for searching a first unexposed frame and setting it at a photographing position.

### DETAILED DESCRIPTION OF THE PREFERRED EMBODIMENTS

An explanation will be given of embodiments of the invention as follows.

First, an explanation will be given of a position of a magnetic recording portion formed on a film used in APS and the constitution related thereto which is used in a first through a fourth embodiment explained below.

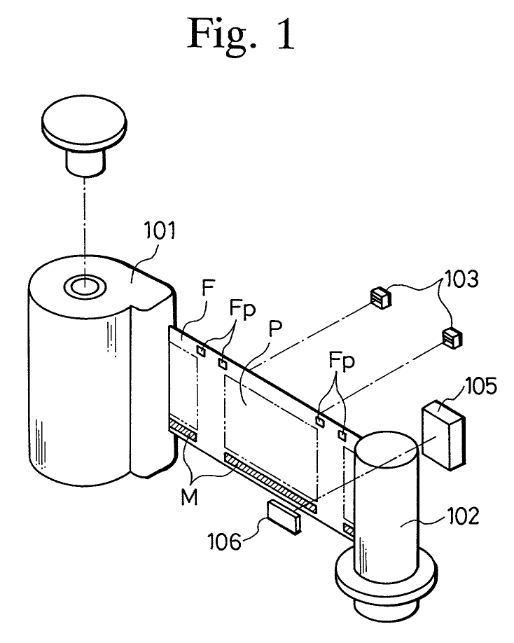

FIG. 1 is a view showing a cartridge, a spool, a film and a position of a magnetic recording portion thereof as well as the constitution related thereto in a state in which a film cartridge for APS is loaded at inside of a camera and a front end of the film is wound up to the spool.

In FIG. 1, numeral 101 designates a film cartridge and numeral 102 designates a spool arranged on the side of the camera for winding up the film. The film F is provided with the magnetic recording portion M below a region P coated with a photosensitive material. Further, notation Fp designates perforations for transferring the film, and transfer of the film can be controlled by detecting presence or absence of the perforations by photo-reflectors 103. Further, numeral 105 designates a magnetic head for writing/reading information to and from the magnetic recording portion M and numeral 106 designates a pad for pressing the magnetic recording portion M of the film F to the magnetic head 105.

First Embodiment

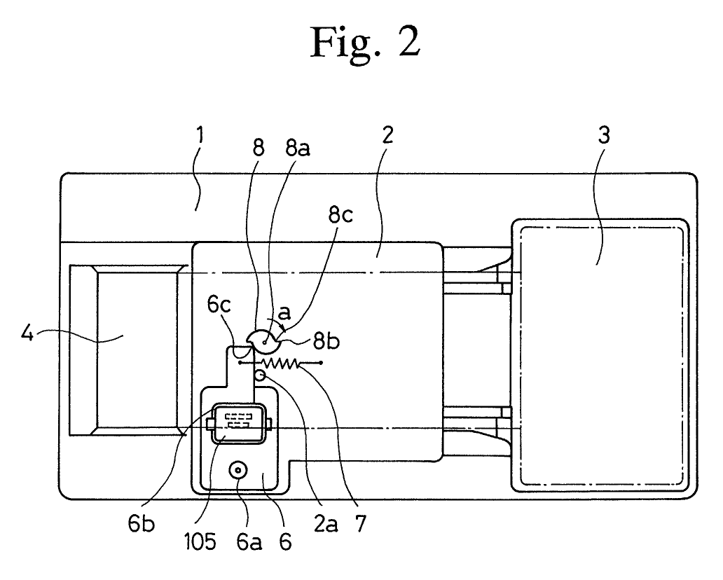

FIG. 2 is a view for explaining a first embodiment of the invention and is a view showing the constitution of an inner portion of a rear face of the camera. In FIG. 2, numeral 1 designates a camera body, numeral 2 designates a press plate for pressing the film to a picture frame from a rear side to maintain it in a plane state, numeral 3 designates a cartridge chamber for containing the film cartridge and numeral 4 designates the spool for winding up the film.

In the press plate 2, a pivoting plate 6 is pivotably supported around a shaft 6a and is urged to pivot in the clockwise direction by a spring 7. Further, the press plate 2 is installed with a pin 2a for locking the pivoting plate 6 urged by the spring 7.

Further, in the press plate 2, a cam 8 is supported rotatably around a shaft 8a and the cam 8 is constituted to rotate in an arrow a direction (clockwise direction) by a drive mechanism, mentioned later. The cam 8 is provided with a cam face in a shape of circular arcs eccentric from the shaft 8a and each of the cam faces is provided with a high cam position 8b remote from the shaft 8a and a low cam position 8c adjacent to the shaft 8a and the cam face of the cam 8 is arranged at a position in contact with a stepped portion 6c of the pivoting plate 6.

By the constitution, when the cam 8 is rotated in the arrow a direction (clockwise direction), the pivoting plate 6 is pivoted in the counter clockwise direction since the stepped portion 6c of the pivoting plate 6 is pressed in the left direction of FIG. 2 by the cam 8 and when the cam 8 is rotated and the stepped portion 6c of the pivoting plate 6 passes through the high cam position 8b, the pivoting plate 6 is pivoted rapidly in the clockwise direction by urge force of the spring 7 until the stepped portion 6c is brought into contact with the low cam position 8c and accordingly, the pivoting plate 6 is rocked in the left and right direction around the shaft 6a.

A hole 6b is formed in the pivoting plate 6 and the magnetic head 105 is attached at the center of the hole 6b at a position opposed to the magnetic recording portion of the film, and the magnetic recording portion of the film is constituted to be able to magnetically record information and read the magnetically recorded information.

In the above-described constitution, when the cam 8 is rotated while winding up the film by the spool 4 in initial loading operation, the pivoting plate 6 is rocked around the shaft 6a and is reciprocated by a very small distance substantially in parallel with the direction of transferring the film. When the pivoting plate 6 is pivoted in the clockwise direction by the urge force of the spring 7, the magnetic head 105 on the pivoting plate 6 is driven in a direction reverse to the direction of transferring the film and accordingly, the speed of moving the film relative to the magnetic head 105 becomes faster than the speed of transferring the film. Further, the magnetic head 105 on the pivoting plate 6 is constituted to move on the same plane.

When the urge force of the spring 7 is adjusted and the speed of moving the magnetic head 105 by the urge force of the spring is set to a speed equivalent to or more than the speed of transferring the film, the speed of moving the film relative to the magnetic head 105 becomes twice as much as the speed of transferring the film or more and output signal generated in the magnetic head becomes larger than in the case in which the magnetic head is fixed.

For example, when the magnetic head is fixed, even when the magnetic recording information can be read at a normal film transferring speed, in the case where the film transferring speed is lowered by lowering power source voltage, lowering environmental temperature or the like, there is a case in which the magnetically recorded information cannot be read. In contrast thereto, when the speed of moving the film is twice as much as or more of the film transferring speed, even when the film transferring speed is lowered, the speed of moving the film relative to the magnetic head can be maintained to a degree of a normal case and the magnetic recording information can firmly be read.

In this case, whether the film transferring speed is equal to or more than a predetermined speed capable of reading the magnetic recording information may be determined directly or from power source voltage, temperature or the like and the magnetic head may be driven by rocking the pivoting plate and the speed of moving the film in respect of the magnetic head may be accelerated only when it is difficult to read the magnetic recording information.

Further, when an angle of rocking the pivoting plate is made equal to or more than ±0.85, there causes a case in which the azimuth angle which is an angle of intersection of the magnetic recording portion on the film and the center line of a gap of the magnetic head becomes zero degree (0°) and accordingly, an optimum value of the azimuth angle is necessarily produced when the magnetic head is reciprocated to rock at least once during a time period in which the magnetic recording portion on the film passes above the magnetic head and accordingly, there can be determined whether the magnetic recording information is present on the frame.

Next, an explanation will be given of a mechanism of driving the cam. Although a film transfer motor, a transferred film, a motor other than the film transfer motor (for example, a mirror drive motor) or the like is conceivable as a drive source of the cam, an explanation will be given of a mechanism of driving the cam by a film transfer motor in this embodiment.

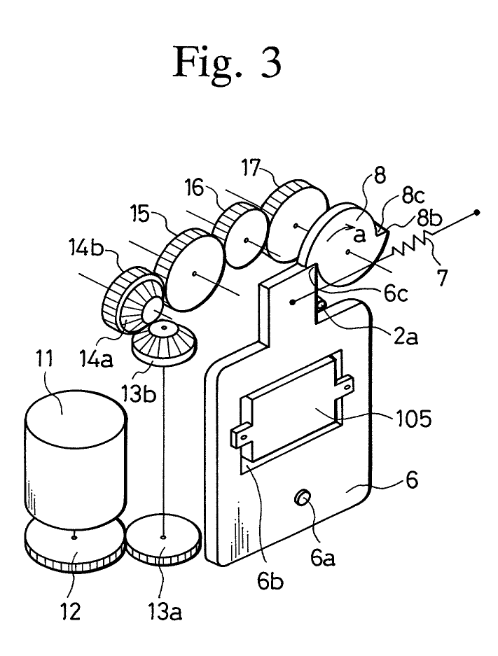

FIG. 3 is a perspective view for explaining a drive mechanism of a cam. In FIG. 3, numeral 11 designates a motor incorporating a speed reduction mechanism constituted by a plurality of gears including gear 12, not illustrated, and is constituted to drive the spool 4 by reducing speed of rotation of a rotor shaft of the motor.

A gear 13a is a spur gear in mesh with a gear 12 which is one of a gear train and the gear 13a is coaxially and integrally fixed with a bevel gear 13b. The bevel gear 13b is in mesh with a bevel gear 14a which is orthogonally intersected therewith and a gear train is constituted to drive a spur gear 17 via a spur gear 14b integrally fixed to the bevel gear 14a and intermediary spur gears 15 and 16. The spur gear 17 is coaxially and integrally attached with the cam 8 and rotational power separated from the gear 12 in mesh with the gear train of the motor 11 is transmitted to the cam 8 via the spur gear 13a, the bevel gear 13b, the bevel gear 14a, the spur gear 14b, the intermediary spur gears 15 and 16 and the spur gear 17 to thereby rotate the cam 8 in an arrow a (clockwise direction) of FIG. 3.

Further, although not illustrated, in respect of dividing to allocate the rotational power to the gear 13a in the motor 11, there are (1) a method of dividing it from a midway of a gear train for driving the spool and (2) a method of dividing it from a midway of the gear train for driving the spool in initial loading. According to the method (1), the structure is simplified and is advantageous when the magnetic head is exclusive for reading. Further, according to the method (2), the gear 13a needs to constitute to become in mesh with the gear train only in initial loading and the structure becomes complicated, however, in the case in which the magnetic head is both for reading and writing, when rotation of the cam 8 is stopped to fix such that the magnetic head is set to a predetermined position, the azimuth angle in writing can be set to a predetermined value.

Further, although in explaining the operation of the constitution shown by FIG. 2, the explanation has been given of an example in which the magnetic recording information is read at initial loading, the magnetic recording information can also be read in rewinding the film. In this case, the direction of exerting the urge force of the spring 7 may be set to be reverse to the direction shown by FIG. 2 and division of power from the motor 11 to the cam 8 may be constituted such that power dividing is carried out in driving to rewind the film spool.

Further, other than reading the magnetic recording information in initial loading, the magnetic recording information can be constituted to read also in rewinding the film. In this case, the direction of exerting the urge force of the spring 7 may be set such that the magnetic head is moved in the direction reverse to the direction of transferring the film when there is carried out operation at a slower speed of the speed for transferring the film in initial loading and the speed for transferring the film in rewinding the film.

Second Embodiment

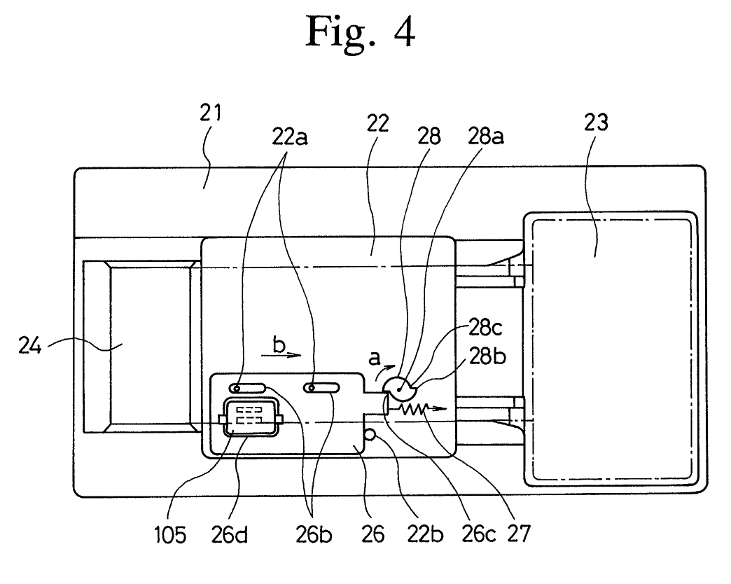

FIG. 4 is a view for explaining a second embodiment of the invention and is a view showing the constitution of an inner portion of a rear face of a camera. In FIG. 4, numeral 21 designates a camera body, numeral 22 designates a press plate for pressing the film from a rear face side to a picture frame to maintain a plane state, numeral 23 designates a cartridge chamber for containing a film cartridge and numeral 24 designates a spool for winding up the film.

A slide plate 26 is supported by the press plate 22 slidably in the left and right direction and is pulled and urged by a spring 27 in the right direction of FIG. 4. Further, notation 26b designates holes for guiding the slide plate 26 in the sliding direction, notation 22a designates pins implanted to the press plate 22 and by fitting the holes 26b to the pins 22a, the slide plate 26 is only slidable in the left and right direction, and stays unmoved in the up and down direction by being restricted thereby. Further, the press plate 22 is installed with a stop pin 22b and movement of the slide plate 26 in the right direction is restricted.

Further, a cam 28 is supported by the press plate 22 rotatably around a shaft 28a and the cam 28 is constituted to rotate in an arrow a direction (clockwise direction) by a drive source, not illustrated, for example, a drive source divided from the motor 11. The cam 28 is provided with a constitution similar to that of the cam 8 explained in the first embodiment, installed with the cam face in a shape of circular arcs eccentric from the shaft 28a, provided with a high cam position 28b remote from the shaft 28a and a low cam position 28c adjacent to the shaft 28a and the cam 28 is arranged at a position in contact with a stepped portion 26c of the slide plate 26.

By the constitution, when the cam 28 is rotated in the arrow a direction (clockwise direction), the stepped portion 26c of the slide plate 26 is pushed by the cam 28 in the left direction of FIG. 4 and therefore, the slide plate 26 is pushed in the left direction of FIG. 4 and when the cam 28 is rotated and the stepped portion 26c of the slide plate 26 passes through the high cam position 28b, the slide plate 26 is rapidly slid in an arrow b direction (right direction of FIG. 4) until the stepped portion 26c is brought into contact with the low cam position 28c by the urge force of the spring 27.

A hole 26d is formed in the slide plate 26 and the magnetic head 105 is attached to its center at a position opposed to the magnetic recording portion of the film and is constituted to be able to magnetically record information to the magnetic recording portion of the film and read magnetically recorded information.

In the above-described constitution, in the case in which the cam 28 is rotated when the film is being wound up by the spool 24 in initial loading, the slid plate 26 is reciprocated by a very small distance in parallel with the left and right direction of FIG. 4, that is, in a direction of transferring the film. When the slide plate 26 is moved in the arrow b direction (right direction of FIG. 4) by the urge force of the spring 27, the magnetic head 105 on the slide plate 26 is driven in a direction reverse to the direction of transferring the film and accordingly, the speed of moving the film relative to the magnetic head 105 becomes faster than the speed of transferring the film.

When the urge force of the spring 27 is adjusted and the speed of moving the magnetic head 105 by the urge force of the spring is set to be a speed equivalent to or more than the speed of transferring the film, the speed of moving the film relative to the magnetic head 105 becomes twice or more of the speed of transferring the film and output signal generated in the magnetic head becomes larger than in the case in which the magnetic head is fixed.

For example, in the case in which the magnetic head is fixed, although the magnetic recording information is constituted to be able to read at a normal speed of transferring the film, when the power source voltage is lowered or the speed of transferring the film is lowered by lowering of environmental temperature or the like, there is a case in which the magnetic recording information cannot be read. In contrast thereto, when the speed of moving the film relative to the magnetic head is twice or more of the speed of transferring the film, even when the speed of transferring the film is lowered, the speed of moving the film relative to the magnetic head can be maintained to a degree of the normal case and the magnetic recording information can firmly be read.

In this case, whether the speed of transferring the film is equal to or more than a predetermined speed capable of firmly reading the magnetic recording information may be determined directly or from power source voltage or temperature and only when reading is determined to be difficult, the magnetic head may be driven by reciprocating the slide plate in the left and right direction and the speed of moving the film relative to the magnetic head may be accelerated.

According to the constitution, the slide plate, that is, the magnetic head is constituted to reciprocate in the left and right direction and accordingly, the azimuth angle that is an angle of intersection of the magnetic recording portion above the film and the center line of a gap of the magnetic head is maintained to substantially a constant value. Accordingly, when driving of the cam 28 is stopped in writing the information to the magnetic recording portion, the azimuth angle can be maintained at a constant value regardless of the rotational angular position of the cam 28 and the rotational angular position of the cam 28 needs not to investigate.

Next, an explanation will be given of a drive mechanism of the cam. As a drive source of the cam, although there is conceivable a film feed motor, a film to be fed, a motor other than the film feed motor (for example, mirror drive motor) or the like, in this case, an explanation will be given of a drive mechanism of the cam with a film to be fed as a drive source.

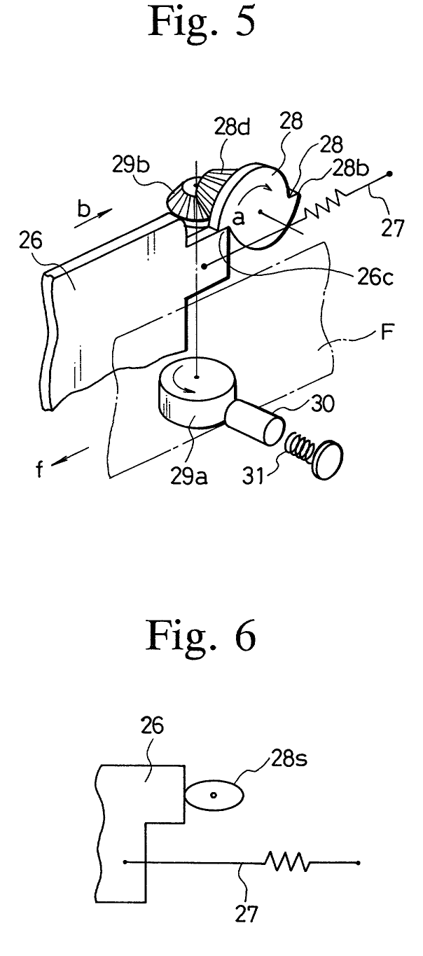

FIG. 5 is a perspective view of essential portions f or explaining the constitution of a drive mechanism of the cam with the film as a drive source. The press plate 22 is rotatably attached with a film roller 29a rotated by movement of the film by being brought into frictional contact with the film F and the film roller 29a is attached with a bevel gear 29b coaxially fixed thereto. Further, the cam 28 is fixed with a bevel gear 28d coaxially therewith and the bevel gear 28d is in mesh with the bevel gear 29b.

In the meantime, on the side of the camera body, there is arranged a pad 30 for pressing the film F to the roller 29a at a position opposed to the roller 29a and the pad 30 is urged to the roller 29a by a spring 31.

In the above-described constitution, when the film F travels in a direction of winding up the film F (arrow f direction) the roller 29a which is brought into frictional contact with the film F and the bevel gear 29b are rotated, the cam 28 is rotated in the arrow a direction (clockwise direction) of FIG. 4 and FIG. 5 via the bevel gear 28d and accordingly, the slide plate 26 can be reciprocated in the arrow b direction and a direction opposed thereto (left and right direction).

When the film F travels in the direction of rewinding, the cam 28 is rotated in the counter clockwise direction of FIG. 4 and FIG. 5 and as is apparent from the constitutions shown by FIG. 4 and FIG. 5, in rotating the cam 28, the stepped portion 26c of the slide plate 26 is engaged with the cam face 28c and rotation of the cam 28 is blocked. Therefore, in rewinding the film F, the pad 30 is escaped and the film F is constituted to prohibit from being pressed to the roller 29a. Although the mechanism of escaping the pad 30 is not illustrated here, the pad 30 may be driven by a rewind switch mechanism of the film F.

Further, when the shape of the cam 28 is constituted by that of a cam 28s in an elliptic shape as shown by FIG. 6, the slide plate 26 can be reciprocated in the left and right direction of FIG. 6 in either of cases of rotating the cam 28s in the clockwise direction and rotating it in the counter clockwise direction and the escape mechanism of the pad 30 mentioned above is not needed. Incidentally, in this constitution, when the slide plate 26 is moved in the right direction of FIG. 6, the speed of moving the slide plate 26 is restricted by the cam 28s even with traction by the spring 27. By constituting the shape of the cam by that of the cam 28s in an elliptic shape as shown by FIG. 6, the magnetic recording information can be read in either of a case of initial loading and a case of rewinding the film.

Third Embodiment

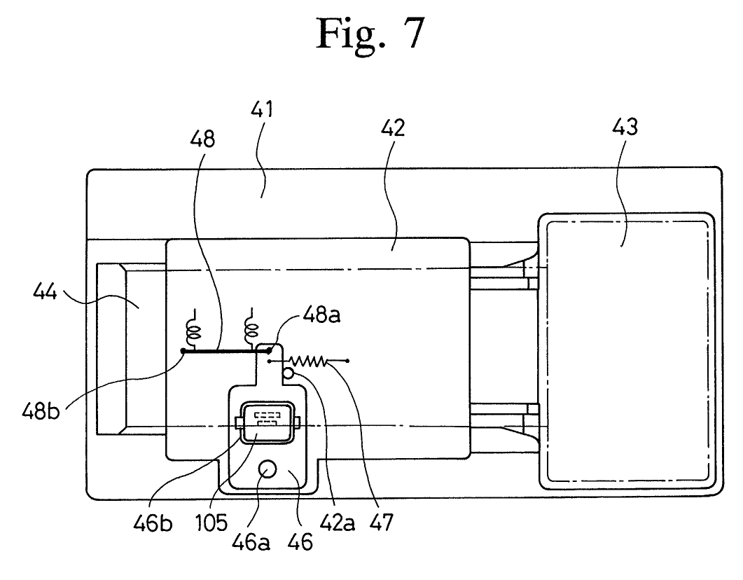

FIG. 7 is a view for explaining a third embodiment of the invention and is a view showing the constitution of an inner portion of a rear face of a camera. In FIG. 7, numeral 41 designates a camera body, numeral 42 designates a press plate for pressing the film from a rear face side to a picture frame to maintain the film in a plane state, numeral 43 designates a cartridge chamber for containing a film cartridge and numeral 44 designates a spool for winding up the film.

A pivoting plate 46 is supported by the press plate 42 pivotably around a shaft 46a and is urged to pivot in the clockwise direction by a spring 47. Further, the press plate 42 is installed with a pin 42a for locking the pivoting plate 46 urged by the spring 47.

A hole 46b is formed in the pivoting plate 46 and the magnetic head 105 is attached to its center at a position opposed to the magnetic recording portion of the film and is constituted to be able to magnetically record information to the magnetically recording portion of the film and read magnetically recorded information.

Further, one end 48a of a wire 48 made of a shape memory alloy is attached to the pivoting plate 46 and other end 48b of the wire 48 is fixed to the press plate 42. The wire 48 made of a shape memory alloy is previously memorized with a predetermined contraction shape in this case.

The pivoting plate 46 is urged to pivot in the clockwise direction by the spring 47 and therefore, the wire 48 made of a shape memory alloy is elongated in a normal state, however, when the wire 48 is heated to predetermined temperature by generating heat by resistance of the wire per se by flowing electric current in the wire 48, the wire 48 is contracted to recover to the memorized shape and accordingly, the pivoting plate is pivoted in the counter clockwise direction against the urge force of the spring 47. When electric current to the wire 48 is cut off, the wire is cooled and accordingly, the pivoting plate 46 again recovers to the position shown by FIG. 7 by being pivoted in the clockwise direction by the spring 47.

In the above-described constitution, in the case in which the film is being wound up by the spool 44, when supplying and cutting off of electric current is repeated in the wire 48 made of a shape memory alloy, the pivoting plate 46 is pivoted around the shaft 46a and is reciprocated by a very small distance substantially in parallel with the direction of feeding the film. In this case, when the pivoting plate 46 is pivoted in the clockwise direction by the urge force of the spring 47, the magnetic head 105 on the pivoting plate 46 is driven in a direction reverse to the direction of feeding the film and accordingly, the speed of moving the film relative to the magnetic head 105 becomes faster than the speed of feeding the film.

When the urge force of the spring 47 is adjusted and the speed of moving the magnetic head 105 by the urge force of the spring is set to be a speed equivalent to or more than the speed of feeding the film, the speed of moving the film relative to the magnetic head 105 becomes twice or more of the speed of feeding the film, output signal generated in the magnetic head becomes larger than in the case in which the magnetic head is fixed, even when the speed of feeding the film is lowered, the speed of moving the film relative to the magnetic head can be maintained to a degree of the normal case and the magnetic recording information can firmly be read.

Further, when the pivoting angle of the pivoting plate is set to be equal to or more than±0.85°, there causes a case in which the azimuth angle which is an angle of intersection of the magnetic recording region on the film and the center line of a gap of the magnetic head becomes zero degree (0°) and accordingly, an optimum value of the azimuth angle is necessarily caused when the magnetic head is reciprocated at least once during a time period in which the magnetic recording region on the film passes through above the magnetic head and therefore, whether the magnetic recording information is present or not in the frame can be determined quite similar to the case of the first embodiment.

Further, although the urge force of the spring 47 is utilized for driving the slide plate 46 in a direction reverse to the direction of winding the film in FIG. 7, when the drive speed by heating/cooling the wire 48 made of a shape memory alloy is faster than the drive speed by the urge force of the spring 47, drive by the wire made of a shape memory alloy may be constituted to utilize in the driving operation in the direction reverse to the direction of winding up the film. There is adopted driving means of a faster one of the drive speed by utilizing either of the driving operation by the urge force of the spring and the driving operation by the wire made of a shape memory alloy in driving the pivoting plate in a direction reverse to the direction of winding up the film.

Although in the above-described explanation, an example of reading the magnetic recording information in initial loading has been shown, the magnetic recording information can also be read in rewinding the film, further, similar to the first and the second embodiments, the magnetic-recording information may be read both in initial loading and rewinding the film.

According to the constitution, a cam for driving the magnetic head and a mechanism of rotating the cam are not needed as in the first embodiment and the second embodiment and accordingly, the constitution can be simplified and when the wire made of a shape memory alloy is arranged linearly as shown by FIG. 7, no special space is particularly needed.

Fourth Embodiment

According to a fourth embodiment, operation of driving a pivoting plate by a wire made of a shape memory alloy explained in the third embodiment mentioned above is applied to driving a slide plate explained in the second embodiment.

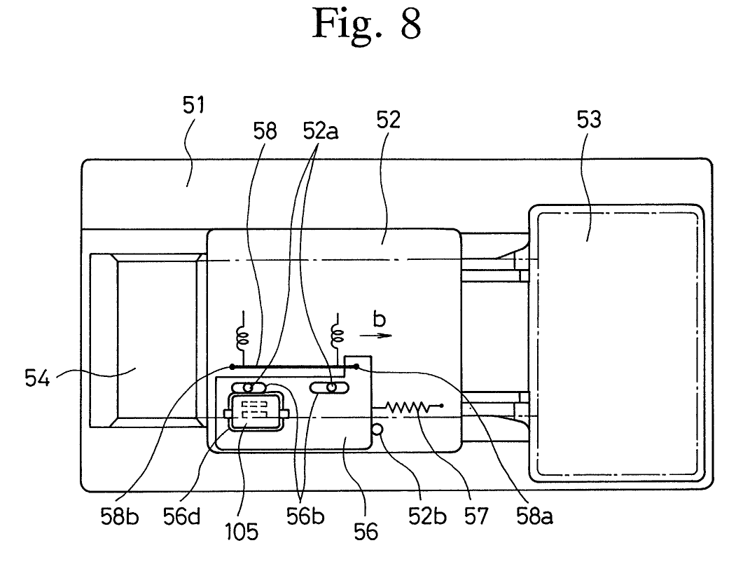

FIG. 8 is view for explaining the fourth embodiment and is a view showing the constitution of an inner portion of a rear face of a camera. In FIG. 8, numeral 51 designates a camera body, numeral 52 designates a press plate for pressing a film from a rear face side to a picture frame to maintain the film in a plane state, numeral 53 designates a cartridge chamber for containing a film cartridge and numeral 54 designates a spool for winding up the film.

A slide plate 56 is supported by the press plate 52 slidably in the left and right direction and is pulled and urged in an arrow b direction (right direction of FIG. 8) by a spring 57. Further, notation 56b designates holes for guiding the slide plate 56 in the sliding direction and numeral 52a designates pins implanted to the press plate 52 and by fitting the pins 52a into the holes 56b mentioned above, the slide plate 56 is slidable in the left and right direction, and stays unmoved in the up and down direction by being restricted thereby. Further, the press plate 52 is installed with a lock pin 52b to restrict movement of the slide plate 56 in the right direction.

A hole 56d is formed in the slide plate 56 and the magnetic head 105 is attached to its center at a position opposed to the magnetic recording portion of the film and is constituted to be able to magnetically record information to the magnetic recording portion of the film and read magnetically recorded information.

Further, one end 58a of a wire 58 made of a shape memory alloy is attached to the slide plate 56 and other end 58b of the wire 58 is fixed to the press plate 52. The wire 58 made of a shape memory alloy is previously memorized with a predetermined contraction shape in this case.

The slide plate 56 is urged to slide in the arrow b direction (right direction of FIG. 8) by a spring 57 and accordingly, the wire 58 made of a shape memory alloy is elongated in the normal state, however, when electric current is flowed in the wire 58 and the wire 58 is heated to a predetermined temperature by generating heat by resistance of the wire per se, the wire 58 is recovered to contract to the memorized shape and accordingly, the slide plate 56 is slid in a direction opposed to the arrow b (left direction of FIG. 8) against the urge force of the spring 57. When electric current to the wire 58 is cut off, the wire is cooled and therefore, the wire 58 is again slid to the arrow b direction (right direction of FIG. 8) by the spring 57 and is returned to a position shown by FIG. 8.

In the above-described constitution, in the case in which the film is being wound up by the spool 54, when conduction and cutting off of electric current is repeated at the wire 58 made of a shape memory alloy, the slide plate 56 is reciprocated by a very small distance in parallel with the arrow b direction and the direction opposed thereto (left and right direction), that is, the direction of transferring the film. At this occasion, when the slide plate 56 is slid in the arrow b direction (right direction of FIG. 8) by the urge force of the spring 57, the magnetic head 105 on the slide plate 56 is driven in the direction reverse to the direction of feeding the film and accordingly, the speed of moving the film relative to the magnetic head 55 becomes faster than the speed of feeding the film.

When the urge force of the spring 57 is adjusted and the speed of moving the magnetic head 105 by the urge force of the spring is set to be a speed equivalent to or more than the speed of feeding the film, the speed of moving the film relative to the magnetic head 105 becomes twice or more of the speed of feeding the film, output signal generated in the magnetic head becomes larger than in the case in which the magnetic head is fixed, even when the speed of feeding the film is lowered, the speed of moving the film relative to the magnetic head can be maintained to a degree of the normal case and the magnetic recording information can firmly be read.

Further, according to the constitution, similar to the case of the third embodiment mentioned above, a cam for driving the magnetic head and a mechanism for rotating the cam are not needed and accordingly, the constitution can be simplified, further, when the wire made of a shape memory alloy is arranged linearly above the press plate as shown by FIG. 8, no special space is particularly needed.

Further, similar to the second embodiment mentioned above, according to the constitution, the slide plate, that is, the magnetic head is reciprocated in the left and right direction and accordingly, the azimuth angle which is an angle of intersection of the magnetic recording region on the film and the center line of a gap of the magnetic head, can be maintained to a substantially constant value.

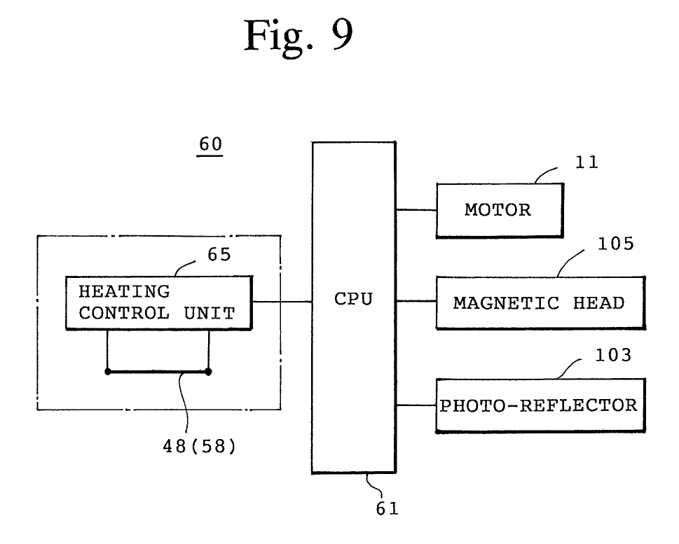

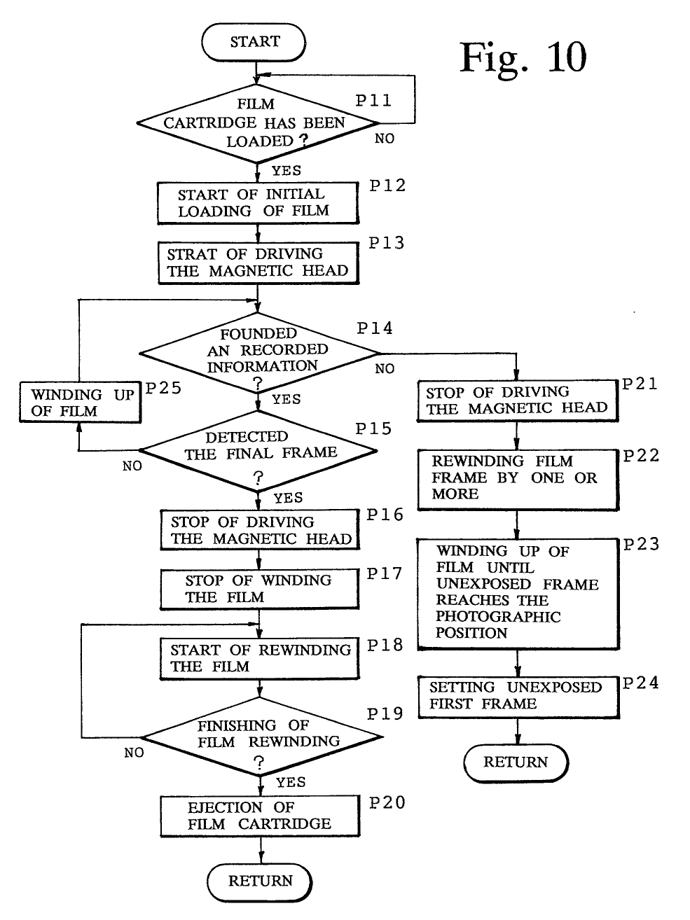

FIG. 9 is a block diagram for explaining the constitution of a control circuit of a magnetic recording information reading device which is applicable to those of the first and the second embodiments mentioned above. In FIG. 9, a constitution added with a constitution of a portion indicated by a chain line is applicable to those of the third and the fourth embodiments.

A control circuit 60 is constituted by CPU (Central Processing Unit) 61, a motor 11, a magnetic head 105 and a photo-reflector 103 which are connected to input/output ports of CPU 61. The control circuit 60 according to the third and the fourth embodiments is constituted to connect the wire 48 (third embodiment) or 58 (fourth embodiment) made of a shape memory alloy via a heating control unit 65 for supplying electric power to the wire made of a shape memory alloy. The motor 11 is used in transferring the film F and driving the cam drive mechanism for driving the pivoting plate 6.

Next, an explanation will be given of an outline of the operation. When a switch, not illustrated, is made ON, control operation by CPU 61 is started. When loading of a film cartridge is detected, the film is wound up by the motor 11 and initial loading is started.

Perforations of the film are detected by the photo-reflector 103 and transfer of the film is controlled.

Simultaneously therewith, according to the first and the second embodiments, the pivoting plate 6 or the slide plate 26 is driven by the cam drive mechanism and movement of the magnetic head 105 is started. According to the third and the fourth embodiments supplying and cutting off of electric power is started at the wire 48 or 58 made of a shape memory alloy via the heating control unit 65, the pivoting plate 46 or the slide plate 56 is driven and movement of the magnetic head 105 is started.

The magnetic recording information on the film is read by the magnetic head 105 and based on the recorded information, control of transfer of the film, stop at a photographing position and so on is carried out.

FIG. 10 is a flowchart for explaining control operation of the control circuit 60 for searching an initial unexposed frame and setting it at a photographing position when a film cartridge which has been photographed until a midway thereof is reloaded in a camera according to the first through the fourth embodiments explained above.

First, the operation awaits for loading of the film cartridge to a cartridge chamber of the camera (step P11) and starts initial loading when it is loaded (step P12). During a procedure of winding a film in the initial loading, the operation starts to drive a magnetic head, that is, pivot or reciprocate the magnetic head (step P13) and searches an information item recorded on the magnetic recording portion in correspondence with respective frames on the film (step P14).

When the recorded information is discovered, the operation determines whether the recorded information is of a final frame or not (step P15). When the recorded information is not of the final frame, continues winding up the film (step P25) and returns to step P14. When the recorded information is of the final frame by determination at step P14, it signifies that all the frames of the film cartridge have been photographed and accordingly, the operation stops to drive the magnetic head (step P16) and stops winding up the film (step P17). Further, the operation starts rewinding the film and awaits for finish of the rewinding operation (steps P18 and P19). When the rewinding operation has been finished, ejects the film cartridge (step P20) and finishes the processing.

When it is determined that there is no recorded information in the magnetic recording portion by the judgement at P14, the frame is determined to be an initial unexposed frame and accordingly, the operation stops driving the magnetic head (step P21), stores a number of the unexposed frame, rewinds the frame by one frame or more (step P22), winds up the film (step P23) until the frame having the unexposed frame number reaches the photographing position (step P23), sets the unexposed first frame at the photographing position (step P24) and returns to an exposure control routine, not illustrated.

Although according to the above-described explanation, when it is determined that there is no recorded information at the magnetic recording portion by determination at step P14, driving of the magnetic head is stopped at steps P21 and P22, the unexposed frame number is stored and the film is rewound by one frame or more, presence or absence of the recorded information at the magnetic recording portion may be determined by driving the magnetic head even in rewinding the film, the determination may be compared with a result of determination at step P14, when results of both determination coincide with each other, the film may be wound up until the frame having the unexposed frame number reaches the photographing position and when the results of determination do not coincide with each other, the operation may return to step P12 and may start driving again the magnetic head in the procedure of winding up the film and may determine presence or absence of information at the magnetic recording portion. Thereby, an error in reading the recorded information can be prevented. Further, when the results of both determination mentioned above do not coincide with each other, alarm may be displayed.

According to the embodiments of the invention explained above, an explanation has been given by an example in which the invention is applied to a magnetic recording information reading device of a camera using the film cartridge for APS. However, the invention is not limited to such a magnetic recording information reading device of a camera but is naturally applicable to other device utilizing magnetic information on a film having a magnetic recording portion, that is, a magnetic recording information reading device of, for example, a photo player, a film scanner or the like.

As has been explained, according to the invention, in a magnetic recording information reading device using a film cartridge capable of magnetically recording information on a film, by reciprocating a read head for reading magnetic recording information recorded on a magnetic recording portion by a small distance in parallel with a direction of transferring the film, a speed of the magnetic recording portion passing through the read head is accelerated and a level of a signal outputted from the read head is increased.

Thereby, the speed of the magnetic recording portion passing through the read head can be accelerated without accelerating the speed of transferring the film, even when an angle (azimuth angle) between a magnetism change boundary line of the magnetic recording portion and the center line of a gap of the head is not strictly set within a predetermined angle, an output signal having a sufficient level is obtained from the read head and the magnetic recording information can be read easily and firmly.

Further, it is not necessary to use a film guide mechanism for strictly setting the angle (azimuth angle) made by the magnetism change boundary line of the magnetic recording portion and the center line of a gap of the head within a predetermined angle, a large-sized motor for accelerating the speed of transferring the film and the like and the device can be arranged in small size and light weight.

What is claimed is:

1. A magnetic recording information reading device comprising:
a transfer mechanism for transferring a record medium having a magnetic recording portion;
a magnetic head for reading information recorded on the magnetic recording portion of the transferred record medium; and
a moving mechanism for moving the magnetic head in a direction reverse to a direction of transferring the record medium.

2. A magnetic recording information reading device according to claim 1:
wherein the moving mechanism moves the magnetic head in one plane.

3. A magnetic recording information reading device according to claim 1, further comprising:
a control device for controlling the transfer mechanism such that a predetermined portion of the record medium is stopped at a predetermined position based on the information read by the magnetic head.

4. A magnetic recording information reading device according to claim 3:
wherein the record medium is a photographic film.

5. A magnetic recording information reading device according to claim 4:
wherein the information read by the magnetic head is information recorded at respective frames on the photographic film for indicating whether the frames have not been photographed.

6. A magnetic recording information reading device according to claim 5:
wherein the predetermined portion is the frame which has not been photographed and the predetermined position is a photographing position.

7. A magnetic recording information reading device according to claim 1:
wherein the moving mechanism includes a rotating axis and the moving mechanism moves the magnetic head around the rotating axis.

8. A magnetic recording information reading device according to claim 1:
wherein the moving mechanism moves the magnetic head in the direction reverse to the direction of transferring the record medium by a force of a spring.

9. A magnetic recording information reading device according to claim 8:
wherein the moving mechanism further comprising:
a displacement member for displacing the magnetic head in the direction of transferring the record medium.

10. A magnetic recording information reading device according to claim 9:
wherein the displacement member is a cam.

11. A magnetic recording information reading device according to claim 9:
wherein the displacement member is a displacement member constituted by a shape memory alloy.

12. A magnetic recording information reading device according to claim 9:
wherein the moving mechanism f or moving the magnetic head is driven by a movement of the record medium in the direction of transferring the record medium.

13. A magnetic recording information reading device according to claim 1, further comprising:
a pad for pressing the record medium to the magnetic head.

14. A magnetic recording information reading device comprising:
a transfer mechanism for transferring a record medium having a magnetic recording portion;
a magnetic head for reading information recorded on the magnetic recording portion of the transferred record medium; and
an angle change mechanism for changing a reading angle of the magnetic head.

15. A magnetic recording information reading device according to claim 14:
wherein the record medium is a photographic film.

16. A magnetic recording information reading device according to claim 15:
wherein the information read by the magnetic head is information recorded at respective frames on a photographic film for indicating whether the frames have not been photographed.

17. A magnetic recording information reading device according to claim 16, further comprising:
a control mechanism for positioning the frame which has not been photographed at a photographing position by stopping the photographic film in accordance with the read information.

18. A magnetic recording information reading device according to claim 14:
wherein the angle change mechanism moves the magnetic head in a direction reverse to a direction of transferring the record medium while changing the reading angle of the magnetic head.

19. A magnetic recording information reading device according to claim 14:
wherein the angle change mechanism includes a rotating axis and the angle change mechanism moves to rotate the magnetic head around the rotating axis.

20. A magnetic recording information reading device according to claim 19:
wherein the angle change mechanism moves to rotate the magnetic head by 1.7 degree or more during a time period of reading operation of the magnetic head.

21. A magnetic recording information reading device comprising:
a transfer mechanism for transferring a record medium having a magnetic recording portion;
a magnetic head for reading information recorded on the magnetic recording portion of the transferred record medium; and
a moving mechanism for reciprocating the magnetic head in a direction of transferring the record medium.

22. The magnetic recording information reading device according to claim 21:
wherein the moving mechanism includes a rotating axis and the moving mechanism moves to rotate the magnetic head around the rotating axis.

23. A camera comprising:
a transfer mechanism for transferring a photographic film having a magnetic recording portion;
a magnetic head for reading information recorded on the magnetic recording portion of the transferred photographic film for indicating whether frames thereof have been photographed;
a moving mechanism for moving the magnetic head in a direction reverse to a direction of transferring the photographic film in reading the information recorded on the magnetic recording portion; and
a photographic film transfer controlling mechanism for positioning the frame which has not been photographed at a photographing position by controlling to continue or stop to transfer the photographic film in accordance with whether the read information indicates the frames which have been photographed.
